(19) United States
(12) Patent Application Publication
(10) Pub. No.: US 2009/0217997 A1
(43) Pub. Date: Sep. 3, 2009

(54) Thin welded sheets fluid pathway

(76) Inventor: Alan Feinerman, Skokie, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/919,834

(22) PCT Filed: May 4, 2006
(86) PCT No.: PCT/US06/16799

§ 371 Date: Jan. 12, 2009

Related U.S. Application Data
(60) Provisional application No. 60/677,535, filed on May 4, 2005.
(60) Provisional application No. 60/677,691, filed on May 4, 2005.
(60) Provisional application No. 60/709,778, filed on Aug. 20, 2005.

(51) Int. Cl. F15C 3/00; B29C 65/14; B32B 37/00

(52) U.S. Cl. 137/833; 156/290; 156/275.1

(57) ABSTRACT

A plurality of thin welded sheets (102) of an apparatus (100) in an example comprises a plurality of weld lines (304) that defines a plurality of fluid boundaries of a fluid pathway (305) of the plurality of thin welded sheets (102). In a further example, a plurality of thin sheets (102) is welded to form a plurality of weld lines (304) that defines a plurality of fluid boundaries of a fluid pathway (305) of the plurality of thin sheets (102).

### BACKGROUND

Exemplary plastic components are easily laser welded when one component is clear and the other is opaque to the laser beam. One is transparent, the other is not. The laser beam penetrates the upper, transparent joining part and is completely absorbed by the lower, dark surface. The radiation is converted into localized heat and melting takes place. The heat required to melt the transparent joining part is received from the thermal conduction of the absorbing part. Strong welding of both parts occurs under external compression and the internal joining pressure, arising from local warming and expansion.

RF welding, a form of dielectric heating is one of the most widely used methods for assembling medical devices. The process offers: consistent quality; thin, strong weld lines and/or seams; short sealing cycles for high output; minimal thermal distortion of the film or substrate; and the ability to produce weld edge tear seals. Of these, an exemplary important advantage is extremely thin weld lines and/or seams. Impulse welding and hot bar sealing in an example produce a seal that is about 0.125 in. (0.3175 cm) wide—too wide for some exemplary medical applications. For exemplary applications such as containers, the width of the line and/or seam is relatively less significant, but for implantable medical devices, a thinner line and/or seam would be desirable.

Welding clear to clear components in an example requires use of dye that strongly absorbs the radiation. Such exemplary dyes are expensive and subject to FDA (Food and Drug Administration) approval.

Exemplary microvalves comprise devices that are used to control and distribute flow on the microscale. Exemplary applications of these devices comprise mass flow controllers for semiconductor manufacture, refrigerant liquid control systems, biomedical applications such as gas or liquid chromatography, and devices to control flow over airfoil surfaces.

As Gregory Kovacs points out in his textbook Micromachined Transducers Sourcebook (G. T. A. Kovacs, McGraw-Hill, New York, 1998, pg. 823), an exemplary microfluidic valve may be discussed in connection with the following attributes: “a) zero leakage, b) zero power consumption, c) zero dead volume, d) infinite differential pressure capability, e) insensitivity to particulate contamination, f) zero response time (“infinitely fast” state change), g) potential for linear operation, and h) ability to operate with a wide variety of liquids and gasses of any density/viscosity/chemistry.”

### SUMMARY

The invention in an implementation encompasses an apparatus. The apparatus comprises a plurality of thin welded sheets that comprises a plurality of weld lines that defines a plurality of fluid boundaries of a fluid pathway of the plurality of thin welded sheets.

Another implementation of the invention encompasses a process. Two thin, compliant, thermoplastic polymer film sheets are welded so a separation of weld lines between the two thin, compliant, thermoplastic polymer film sheets forms a valve. A thin metal coating is deposited on at least a portion of the two thin, compliant, thermoplastic polymer film sheets to allow an application of an electrostatic force to the thin metal coating that closes the valve.

A further implementation of the invention encompasses a process. A thin electrically conductive layer is deposited on at least a portion of a first optical component. The thin electrically conductive layer serves to absorb electromagnetic radiation of a selected wavelength. The first optical component is optically transparent and allows electromagnetic radiation of the selected wavelength to pass therethrough. The thin electrically conductive layer comprises a thickness between ten nanometers and one micron. A second optical component is contacted to the thin electrically conductive layer on the first optical component. The second optical component is optically transparent and allows electromagnetic radiation of the selected wavelength to pass therethrough. An emission of electromagnetic radiation of the selected wavelength is directed to the thin electrically conductive layer for absorption by the thin electrically conductive layer. The thin electrically conductive layer converts at least a portion of the emission of electromagnetic radiation into thermal energy that the thin electrically conductive layer conducts to the first optical component and the second optical component to fuse together the first optical component and the second optical component.

### DESCRIPTION OF THE DRAWINGS

Features of exemplary implementations of the invention will become apparent from the description, the claims, and the accompanying drawings in which:

FIG. 1 is a representation of an exemplary implementation of an apparatus that comprises a thin sheet with electrically conductive material.

FIG. 2 is a representation of exemplary holding and bonding of glass sheets with the electrically conductive material of the apparatus of FIG. 1.

FIG. 3 is a cross-sectional schematic representation of an exemplary implementation of a valve that comprises thin sheets with the electrically conductive material and a fluid pathway of the apparatus of FIG. 1.

FIG. 4 is a top schematic representation of the valve of FIG. 3, further illustrating exemplary inlet and outlet tubes.

FIG. 5 is a representation of a prediction of a maximum opening of the valve of FIG. 3.

FIG. 6 is a representation of an exemplary voltage multiplier circuit that is employable with the valve of FIG. 3.

FIG. 7 is a representation of an exemplary multiplication of the fluid pathway of FIG. 3.

FIG. 8 is an enlarged partial representation similar to FIG. 7 and represents an exemplary fluidic connection between two fluid pathways.

FIG. 9 is a representation of exemplary holding and bonding of thin sheets with the electrically conductive material of the apparatus of FIG. 1.

FIG. 10 is a cross-sectional view of the apparatus shown in FIG. 9.

FIG. 11 is an exemplary representation of selectively attaching a plurality of fluid pathways to a rigid substrate and creating plurality of free edges.

FIG. 12 is an exemplary representation of an electrically isolated microvalve that is closed with assistance of adjacent reservoir.

FIG. 13 is another exemplary representation of an electrically isolated microvalve that is closed with assistance of adjacent reservoir.

FIG. 14 is an exemplary representation of measuring a force by electrically measuring fluid position in a fluid pathway.

FIG. 15 is a representation of an exemplary logic flow for an implementation of the apparatus of FIG. 1.

FIG. 16 is a representation of an exemplary logic flow for an implementation of the apparatus of FIG. 1.

### DETAILED DESCRIPTION

Absorption of electromagnetic radiation for fusion in an example is provided. Dyeless laser and RF (radio frequency) selective welding of clear plastic and glass components in an example is provided, as described herein.

Exemplary optical components for laser welding in an example comprise plastic, glass, and/or other heat-weldable material that is translucent and/or transparent to a laser beam. Plastic components are easily laser welded when one component is clear and the other is opaque to the laser beam. Welding clear to clear components in an example requires use of a dye that strongly absorbs the radiation. These dyes in an example are expensive and can delay the FDA (Federal Drug Administration) approval of medical devices. Clear to clear welding in an example is desired when the devices need to be examined by light in a transmission mode (e.g., fluorescence), and/or for aesthetic and/or other reasons. The need for a dye in an example is eliminated by having an electrically conductive layer that will:
1. strongly absorb the incident radiation, for example, to generate heat within the electrically conductive layer,
2. transfer that heat to the plastic components, and
3. have clear space where the plastic is exposed to allow the plastic components to make intimate contact and weld.

The electrically conductive layer in an example is patterned. For example, the electrically conductive layer is applied in a pre-determined pattern of alternating lines, blocks, rectangles, and/or other shapes of alternating conductive regions and clear regions. In another example, the electrically conductive layer is unpatterned. The electrically conductive layer in an example comprises a thin electrically conductive layer, for example, an electrically conductive nanolayer. The electrically conductive nanolayer in an example comprises a thickness between ten angstroms and twenty-five microns. (1 angstrom=1×10⁻¹⁰ meters; 1 micron=1×10⁻⁶ meters). In another example, the electrically conductive nanolayer comprises a thickness between ten nanometers and one micron. (1 nanometer=1×10⁻⁹ meters.)

The electrically conductive layer in an example comprises a thin metal layer. Metals are strong absorbers of electromagnetic radiation. The attenuation of the electromagnetic energy is approximately exponential with a characteristic distance that is referred to as the “skin depth.” The skin depth is given by the following formula

$$δ = \sqrt{\frac{λ ⋆ ρ}{π ⋆ c ⋆ μ}} ,$$

where λ is the wavelength of the incident radiation, ρ is the resistivity of the metal, c is the speed of light, and μ is the magnetic permeability of the metal (μ=μ0=4π*10⁻⁷ Henries/meter for non-magnetic materials). A typical commercial welder for plastic uses 940 nm laser light to weld plastic and at this wavelength the skin depth with Aluminum is ˜5 nm (ρ is ˜2.7μΩ*cm). Three skin depths of Aluminum (˜15 nm) will absorb nearly all of the incident energy and a layer this thin will not interfere with the two plastic pieces forming intimate contact provided there are open spaces. When other materials are used, the thickness of the layer may be different. A minimum thickness of the layer in an example is such that a sufficient amount of electromagnetic radiation is absorbed to heat the electrically conductive layer and cause fusion of the optical components. In a further example, a maximum thickness of the layer is such that the optical components are able to flow around the electrically conductive layer and/or flow through gaps in the electrically conductive layer to make contact with each other when melted, as described herein.

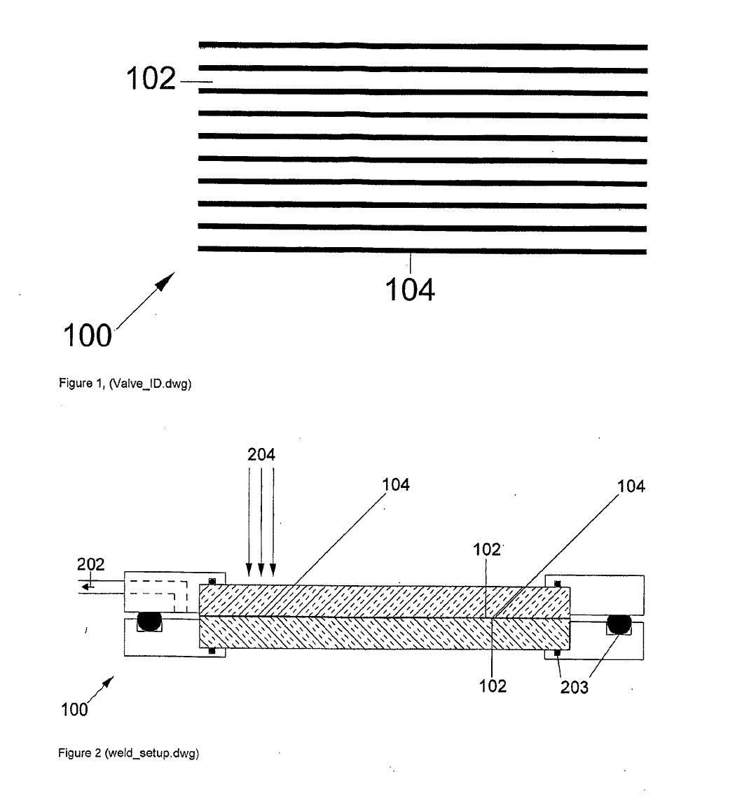

FIG. 1 is a representation of an exemplary implementation of an apparatus 100 that comprises a thin sheet 102 with electrically conductive material 104. The electrically conductive material 104 in an example comprises an electrically conductive layer that may comprise a series of rectangles, thin particulates, and/or a grid in the regions that need to be welded. An example of a rectangle and/or stripes series is illustrated in FIG. 1. The thin sheet 102 in an example comprises an optical component.

The electrically conductive layer is applied to at least a portion of the optical component. The conductive layer can be patterned with standard photolithography, or with a shadow mask that blocks the conductive atoms from reaching the plastic or glass substrate. A shadow mask in an example is used when the plastic to be welded will react with the photoresist chemicals and/or to eliminate the photolithography expense. Since the required conductive thickness in an example is much less than 1 μm, a conventional shadow mask can pattern many pieces before the deposited conductive film needs to be removed. Substantially uniform heating results are achieved in an example if the period of the conductive shapes (e.g., rectangle, square, or other feature) is comparable or smaller than the thickness of the region that needs to be heated. This is typically equivalent to the conductive pattern having comparable or greater spatial frequencies to the inverse of the thickness that needs to be heated. The conductive thickness and shape that provide a selected and/or desired welding speed in an example depend on the incident radiation wavelength, plastic or glass dielectric constant, desired conductive film deposition time, and the clarity required, selected, and/or desired for the welded regions. In a further example, the conductive film thickness can be calculated or empirically determined and is expected to be ˜3 skin depths. A desired conductive film thickness in an example is determined to be a minimum thickness to achieve a desired weld quality. Several methods can deposit conductive film on plastics and glass. Inexpensive methods can create patterned conductive films under 1 □m thick on disposable plastic film packaging materials.

A very thin unpatterned conductive film in an example can work to weld clear to clear components since the substrate material will flow when heated to its softening or melting point, and this will create breaks in the conductive film where bonding can take place. The conductor will also diffuse into the substrate material allowing the material to be bonded. A patterned conductive absorbing layer is expected to enhance bond strength since there will be regions where the plastic or glass material in each component can make intimate contact without a conductive film being present.

If the conductive film layer is thick enough (the minimum thickness in an example depends on the roughness of the plastic pieces), the unbroken conductive film can prevent the plastic pieces from welding. This is useful for creating a dense region where the plastic is alternately welded or not welded.

Clear glass components in an example can be welded together with some modifications to the above-described exemplary technique. The conductive absorbing layer in an example should not react with the glass or lose its ability to strongly absorb incident radiation at the high temperatures required during bonding. The laser radiation in an example can be delivered in very short pulses that do not allow the conductive film atoms time to diffuse significantly into the glass. Exemplary candidates for the conductor are gold, platinum, or silicide. A second modification is needed in an example since most of the commercial laser welding machines typically clamp the pieces to be welded to apply pressure during the weld with a transparent quartz or glass plate. In a further example, it is desirable that the welded parts not also bond to this clamping plate.

FIG. 2 is a representation of exemplary holding and bonding of thin sheets 102 with the electrically conductive material 104. FIG. 2 schematically indicates an exemplary technique to hold pieces together under pressure during laser bonding. This technique has been used successfully to weld 1.4 μm thick sheets of Mylar film as the thin sheets 102. The thin sheets 102 in an example comprise two clear or translucent glass pieces to be welded together.

A vacuum 202 is applied between the two clear or translucent pieces to be welded together. This pushes the pieces together with a pressure, for example, ˜15 psi, without a quartz plate or other solid object contacting the hot glass during the bonding operation. This reduces the required laser power to achieve welding and keeps the heated glass or other clear substrates being welded from contacting the welding fixture. O-rings 203 in an example contribute to an exemplary application of the vacuum 202, as will be appreciated by those skilled in the art.

An exemplary procedure for welding plastic pieces together with a patterned conductive film follows. An exemplary welding procedure is performed with a shadow mask. For example, a shadow mask is obtained from a manufacturer like FotoFab http://www.fotofab.com/, or fabricated in the UIC Nanotechnology Core Facility (NCF) http://www.ncf.uic.edu. A high mesh screen can also be used as a shadow mask. The shadow mask is placed in front of plastic pieces to be used to support the thin sheets 102. The shadow mask is loaded into the physical vapor deposition system. The MAL has used the Varian electron beam deposition system. http://www.ncf.uic.edu/about/facilities.asp?EqID=18. The shadow masks in an example are secured to the plastic pieces with clips or magnets.

Approximately 15 nm (0.015 μm) of aluminum and/or other desired conductive film is deposited through the openings in the shadow mask to create a patterned conductive film on the plastic piece. This conductive film deposition is so short that the plastic pieces are not heated to excessive temperatures. The patterned conductive film comprises an exemplary implementation of the electrically conductive material 104. Metal islands in an example comprise an exemplary implementation of the electrically conductive material 104.

A plastic piece without any conductive film is placed over the plastic piece with the patterned film with the patterned conductive layer at the interface between the pieces. The plastic sandwich is then loaded into a commercial laser welding system which presses the plastic pieces together. Preliminary experiments were carried out on a Leister Technologies Novellus WS machine http://www.leister.com/,.

A laser beam 204 shines through the plastic sandwich and is absorbed by the patterned conductive film as the electrically conductive material 104, allowing the plastic pieces as the thin sheets 102 to be heated and make the intimate contact required for welding.

Experiments have demonstrated that aluminum foil 25.4 □m thick prevents welding of polyethylene sheets together. A continuous 10 nm thick aluminum film does not prevent polycarbonate from welding together if the plastic has been exposed to photo-chemicals which roughen the plastic's surface. A 15 nm aluminum film as the electrically conductive material 104 was deposited through a dense (˜250×250) stainless steel mesh on the rougher side of clear polycarbonate sheet as the thin sheet 102. The opposite side of the polycarbonate was optically smooth. The mesh formed a shadow mask and after the deposition there were ˜60 μm aluminum squares. A second polycarbonate piece as another thin sheet 102 was placed against the first one with its rougher side against the first piece's rough side. The diode laser provided the laser beam 204 that welded the two pieces of clear polycarbonate together and the region that was welded became optically transparent because the two rough surfaces disappeared when the polycarbonate pieces fused together at their interface.

An exemplary alternative to this approach of laser welding two clear plastic or glass pieces employs liquid dyes that strongly absorb electromagnetic radiation, typically with a wavelength ˜1 μm. Since the plastic is expected to weld around the conductive rectangles, shapes, and/or particles then not only can a biologically inert conductive film be chosen, but the plastic as the thin sheets 102 will prevent any fluid from contacting the conductive film as the electrically conductive material 104.

An exemplary advantage of an exemplary approach described herein where the majority of the heat is absorbed in a very thin and well defined region (e.g., the electrically conductive material 104 located on the thin sheets 102 at the weld lines 304) is the increase in the accuracy of the thermal models used to predict the outcome of the laser welding process.

Currently glass components are bonded together with organic materials. A glass to glass bond (e.g., at the interface of the thin sheets 102) will provide a much better hermetic seal, and will allow the package to withstand a wider temperature range since the organic bonding materials typically have a different thermal expansion coefficient than glass and degrade at elevated temperatures.

Experiments have demonstrated that:

1) a very thin deposited film as the electrically conductive material 104, can absorb the electromagnetic radiation (e.g., IR from laser as the laser beam 204)˜15 nm thick.

2) Aluminum foil that is 25.4 μm thick as the electrically conductive material 104, interferes with welding together of the polyethylene sheets as the thin sheets 102.

3) A continuous 10 nm thick aluminum film as the electrically conductive material 104, does not prevent the thin sheets 102 as the polycarbonate from welding together if the plastic has been exposed to photo-chemicals which roughen the plastic's surface.

4) It can be helpful in an implementation to leave spaces in the film as the electrically conductive material 104, for the hot plastic as the thin sheets 102 to make intimate contact. When the metal film as the electrically conductive material 104 is thin as described herein, leaving spaces is not absolutely necessary in an example but creates a stronger bond and a more transparent part since metal film as the electrically conductive material 104 absorbs visible light as well.

5) Having the patterned conductive and/or metal film only in bonding areas in an example is useful. A number of metals work for the welding process in a number of implementations. An exemplary implementation employs gold (Au) or platinum (Pt) since in an example they do not oxidize.

In an example, a layer, for example, a thin conductive layer is deposited on at least a portion of a first component, for example, a first optical component. The thin conductive layer serves to absorb and/or substantially absorb electromagnetic radiation of a selected wavelength. The first optical component is transparent and/or substantially transparent, for example, optically transparent and/or substantially optically transparent. The first optical component allows electromagnetic radiation of the selected wavelength to pass therethrough and/or substantially pass therethrough.

The thin conductive layer in an example comprises a thickness between ten angstroms (1×10⁻⁹ meters) and twenty-five microns (2.5×10⁻⁵ meters). In another example, the thin conductive layer comprises a thickness between ten nanometers (1×10⁻⁸ meters) and one micron (1×10⁻⁶ meters).

A second component, for example, a second optical component is contacted to the thin conductive layer on the first optical component. The second optical component is transparent and/or substantially transparent, for example, optically transparent and/or substantially optically transparent. The second optical component allows electromagnetic radiation of the selected wavelength to pass therethrough and/or substantially pass therethrough.

An emission of electromagnetic radiation of the selected wavelength is directed to the thin conductive layer for absorption and/or substantial absorption by the thin conductive layer. The thin conductive layer converts at least a portion of the emission of electromagnetic radiation into thermal energy that the thin conductive layer conducts to the first optical component and the second optical component to fuse together the first optical component and the second optical component.

An exemplary process comprises the steps of: welding a first thin sheet of thermoplastic polymer film with a second thin sheet of thermoplastic polymer film to form a first welded region for a valve; welding the first thin sheet of thermoplastic polymer film with the second thin sheet of thermoplastic polymer film to form a second welded region for the valve that is separated from the first welded region; and depositing a thin metal coating on one or more of the first thin sheet of thermoplastic polymer film and/or the second thin sheet of thermoplastic polymer film; wherein the valve is caused to close upon an application of an electrostatic force to the thin metal coating.

An exemplary process comprises the steps of: depositing a thin electrically conductive layer on at least a portion of a first optical component, wherein the thin electrically conductive layer serves to absorb electromagnetic radiation of a selected wavelength, wherein the first optical component is optically transparent and allows electromagnetic radiation of the selected wavelength to pass therethrough, wherein the thin electrically conductive layer comprises a thickness between ten nanometers and one micron; contacting a second optical component to the thin electrically conductive layer on the first optical component, wherein the second optical component is optically transparent and allows electromagnetic radiation of the selected wavelength to pass therethrough; and directing an emission of electromagnetic radiation of the selected wavelength to the thin electrically conductive layer for absorption by the thin electrically conductive layer; wherein the thin electrically conductive layer converts at least a portion of the emission of electromagnetic radiation into thermal energy that the thin electrically conductive layer conducts to the first optical component and the second optical component to fuse together the first optical component and the second optical component.

Welded thin sheets 102 of thermoplastic polymer with thin metal coating (e.g., as the electrically conductive material 104) deposited thereon for a valve in an example is provided. An exemplary implementation of the invention encompasses a valve. Exemplary valves comprise microfluidic valves and/or microvalves, as described herein.

As Gregory Kovacs points out in his textbook, “Micromachined Transducers Sourcebook” (G. T. A. Kovacs, McGraw-Hill, New York, 1998, page 823), an exemplary microfluidic valve would have the following attributes: “a) zero leakage, b) zero power consumption, c) zero dead volume, d) infinite differential pressure capability, e) insensitivity to particulate contamination, f) zero response time (“infinitely fast” state change), g) potential for linear operation, and h) ability to operate with a wide variety of liquids and gasses of any density/viscosity/chemistry.” An exemplary implementation comes very close to achieving all of these goals except item d, and has the additional advantage of an easy connection to external tubing.

Microvalves in an example are created by welding two thin sheets 102 of thermoplastic together. The thin sheets 102 of thermoplastic in an example comprise a thickness between 1.0 and 10.0 μm. In another example, the thin sheets 102 of thermoplastic comprise a thickness between 10 and 100 μm. Each plastic sheet has a thin metal coating as the electrically conductive material 104, that can be deposited before or after the welding. The thin metal coating in an example comprises a thickness between 1.0 and 30.0 nanometers. In another example, the thin metal coating comprises a thickness between 30 and 1000 nanometers.

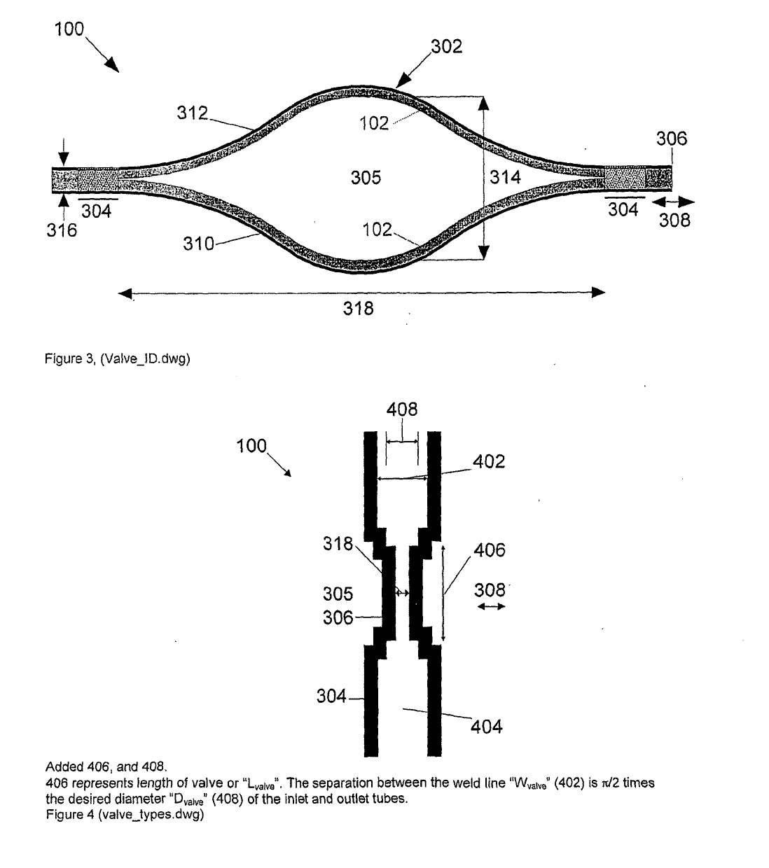

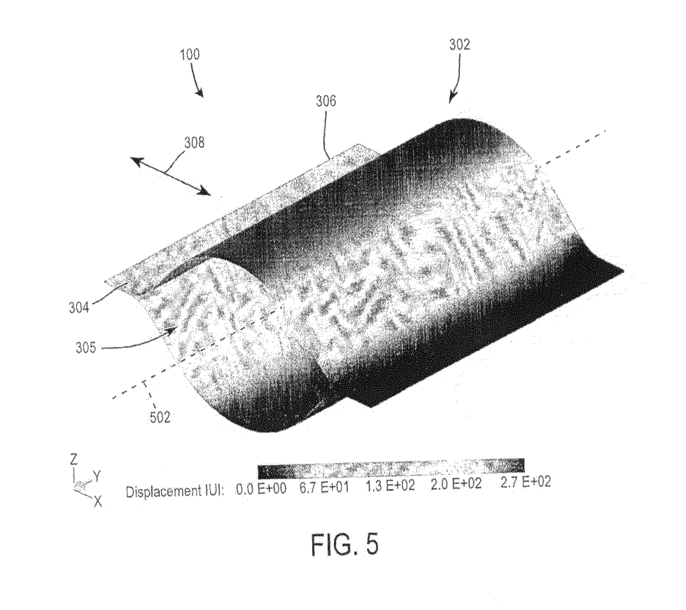

FIGS. 3 and 4 represent an exemplary implementation of a valve 302 that comprises the thin sheets 102 with the electrically conductive material 104. An exemplary implementation of the valve 302 comprises a microvalve. A microvalve as the valve 302 in an example is created by welding together at welded regions and/or lines 304, two sheets of Mylar or other thermoplastic polymer film as the thin sheets 102. The width Wᵥₐₗᵥₑ of the microvalve as the valve 302 in an example is defined by the separation between the two welded regions and/or lines 304. When the microvalve is filled with a fluid (gas or liquid) the two sheets of film as the thin sheets 102 will separate. The microvalve opens because of the pressure difference P_{g} across the walls of the microvalve where P_{g}=“P_{c}”−“Pₒ” and P_{g}>0, where P_{c} is the pressure in channel and/or fluid pathway 305 and Pₒ is atmospheric or ambient pressure. The amount the microvalve as the valve 302 opens due to P_{g} is determined by the plastic film thickness “t_{film}” and Young's modulus, the width of the microvalve, and the clamping method, if any, used to anchor edges 306. Having one or both of the edges 306 of the microvalve as the valve 302 free to move back and forth along exemplary free edge movement directions 308 lowers the pressure difference needed to achieve any opening of the valve 302. Exemplary free edge movement directions 308 in an example are substantially orthogonal with respect and/or relative to a central portion and/or axis 502 (FIG. 5) of the valve 302.

As the microvalve 302 fills with fluid its width projected on a plane below the structure decreases assuming the film does not stretch. The maximum opening of the microvalve is “Oₘₐₓ.” Assuming the films do not stretch, the maximum value for Oₘₐₓ in an example is when the opening is circular with a diameter or 2*Wvalve/□. A large enough voltage difference □V=V1−V2, applied across the two metal films as the electrically conductive material 104 can overcome the P_{g} and will close the microvalve as the valve 302, where in an example V1 is applied to a first of the two metal films and V2 is applied to a second of the two metal films as the electrically conductive material 104.

An apparatus 100 in an example comprises a plurality of thin sheets 102 that comprises a plurality of weld lines 304 that defines a plurality of fluid boundaries of a fluid pathway 305 of the plurality of thin sheets 102. The plurality of weld lines 304 in an example comprises a plurality of thermal weld bonds of fused base material of the plurality of thin sheets 102.

The plurality of thin sheets 102 in an example comprises a plurality of thin, metallized, welded, compliant, biologically substantially inert sheets that is foldable without damage to the plurality of thin, metallized, welded, compliant, biologically substantially inert sheets. The plurality of weld lines 304 in an example comprises a plurality of thermal weld bonds of fused base material of the plurality of thin, metallized, welded, compliant, biologically substantially inert sheets. The plurality of fluid boundaries in an example comprises a plurality of chemically substantially inactive and biologically substantially inert fluid boundaries. The fluid pathway 305 comprises a biological fluid pathway. The plurality of thin, metallized, welded, compliant, biologically substantially inert sheets comprises the plurality of thermal weld bonds that defines the plurality of chemically substantially inactive and biologically substantially inert fluid boundaries of the biological fluid pathway.

The plurality of thin sheets 102 in an example comprises two thin welded compliant sheets that comprise a first thermal weld line and a second thermal weld line that comprise fused base material of the two thin welded compliant sheets. The first thermal weld line as a weld line 304 and the second thermal weld line as a weld line 304 in an example define respective first and second fluid boundaries, of the plurality of fluid boundaries, of the fluid pathway 305. The two thin welded compliant sheets in an example comprise at least one free edge as an edge 306 that is: free to move; and located adjacent to the first thermal weld line and/or the second thermal weld line.

The plurality of thin sheets 102 in an example comprises a plurality of thin welded compliant sheets that comprises: a valve 302 of the fluid pathway 305; and at least one free edge as an edge 306 that is free to move: toward an axis 502 of the valve 302 in response to an increase in fluid flow volume in the valve 302 of the fluid pathway 305; and away from the axis 502 of the valve 302 in response to a decrease in fluid flow volume in the valve 302 of the fluid pathway 305.

The plurality of thin sheets 102 in an example comprises a plurality of thin welded compliant sheets that comprises a self-inflatable valve of the fluid pathway 305. The self-inflatable valve as the valve 302 is inflatable by fluid working pressure in the fluid pathway 305.

The plurality of thin sheets 102 in an example comprises a valve 302 of the fluid pathway 305. A thickness of the plurality of thin welded sheets in an example is substantially less than a width of the valve 302. For example, a thickness of a thin sheet 102 is substantially less than the width of the valve 302.

The microvalve as the valve 302 in an example is defined by the separation between the welded regions and/or lines 304. The width and length of the microvalve are “Wᵥₐₗᵥₑ,” and “Lᵥₐₗᵥₑ,” respectively. The width of the microvalve in an example is between 1 □m and 100 □m. The length of the microvalve in an example is between 1 □m and 1 millimeter. In another example the width is between 100 □m and 30 mm and the length is between 100 □m and 100 millimeters. The fluid pathway 305 in an example comprises inlet 402 and outlet 404. The inlet 402 in an example comprises an inlet tube. The outlet 404 in an example comprises an outlet tube. The connections to the inlet and outlet tubes in an example are facilitated by making “Wᵢₙₗₑₜ” equal to □/2 times the diameter of the tubing, “D_{tube}.” Since Wᵢₙₗₑ The inlet and outlet tubes can be sealed to the microvalve as the valve 302 by using a welding operation, or adhesive to join the plastic film to the inlet and outlet tubes. A friction fit without welding or adhesives in an example can minimize leakage with a proper choice of Wᵢₙₗₑₜ. A gradual taper to the inlet and outlet tubes in an example will facilitate creating a desired friction fit, as will shaping the tube geometry placed into the openings. Substantially and/or almost no dead volume exists between the inlet and outlet tubes. The valve 302 is substantially and/or almost insensitive to particulates because the valve should close down around particulates.

With the microvalve width “Wᵥₐₗᵥₑ” defined by the separation of the welded regions and the amount the microvalve as the valve 302 opens determined by the pressure difference P_{g} between the inside and the outside of the structure and the mechanical characteristics of the thermoplastic film, the capacitance of the closed microvalve as the valve 302 in an example is given approximately by exemplary equation (1). Wᵥₐₗᵥₑ is the width of the valve 302, Lᵥₐₗᵥₑ is the length of the valve 302, t_{film} and □_{film} are the thermoplastic film's thickness and dielectric constant in the valve 302, and □ₒ is the permittivity of free space.

$${C}_{valve} = \frac{{ɛ}_{film} {ɛ}_{o} {W}_{valve} {L}_{valve}}{2 {t}_{film}} \qquad ( 1 )$$

The maximum opening for the microvalve as the valve 302, in an example assuming that the thermoplastic film does not stretch and it opens to a circle, is given in exemplary equation (2) as diameter:

Dᵥₐₗᵥₑ=2*Wᵥₐₗᵥₑ/π. (2)

The average cross-sectional area for the microvalve as the valve 302 with this diameter is given in exemplary equation (3):

Aᵥₐₗᵥₑ=□*Dᵥₐₗᵥₑ²/4=Wᵥₐₗᵥₑ²/π. (3)

The electrostatic energy stored in a closed microvalve as the valve 302 is given in exemplary equation (4):

$${E}_{electrostatic} = \frac{{C}_{valve} Δ {V}^{2}}{2} = \frac{{ɛ}_{film} {ɛ}_{o} {W}_{valve} {L}_{valve} Δ {V}^{2}}{4 {t}_{film}} \qquad ( 4 )$$

where ΔV=V₁−V₂ is the voltage differential across the closed microvalve as the valve 302. The minimum voltage difference required to close the microvalve as the valve 302 can be estimated as follows where z is the direction along the length (Lᵥₐₗᵥₑ) of the microvalve as the valve 302 is given in exemplary equation (5).

$$\begin{matrix}{P}_{g} {A}_{valve} = \frac{{P}_{g} {W}_{valve}^{2}}{π} = - \frac{\partial {E}_{electrostatic}}{\partial z} = - \frac{{ɛ}_{film} {ɛ}_{o} {W}_{valve} Δ {V}_{min}^{2}}{4 {t}_{film}} & ( 5 ) \\ Δ {V}_{min} = \sqrt{\frac{4 {t}_{film} {W}_{valve} {P}_{g}}{π {ɛɛ}_{o}}} & ( 6 )\end{matrix}$$

Exemplary equation (6) gives an estimate of the voltage required to close the microvalve as the valve 302, since exemplary equation (6) does not take into account the mechanical forces (deformation and stretching energies of the thermoplastic film) that also attempt to close the structure and limit the cross-sectional area of the microvalve (Aᵥₐₗᵥₑ) and in practice Oₘₐₓ<Dᵥₐₗᵥₑ. Exemplary equation (6) predicts that 175 volts is needed to close a 1 mm wide microvalve as the valve 302 made from two welded sheets (e.g., as the thin sheets 102) of 1.4 μm thickness when the microvalve is pressurized with air at 500 Pa. Mylar film (e.g., as the thin sheet 102) has a dielectric constant of ˜3. In exemplary experiments on exemplary prototypes, this microvalve as the valve 302 was closed with 350 volts when filled with air at 500 Pa. A microvalve as the valve 302 opened to a full circle would have a 637 □m diameter for a 1 mm wide valve. In exemplary prototype experiments and in exemplary simulations with Coventor™ software (Coventor, Cary, N.C.), the microvalve as the valve 302 opened less than this amount.

FIG. 5 is a representation of a prediction of the maximum opening Oₘₐₓ (FIG. 3) of the valve 302. The Coventor™ software predicts a 540 □m maximum opening Oₘₐₓ. The smaller the maximum opening Oₘₐₓ the less is the voltage that is needed to close the microvalve as the valve 302. A second exemplary prototype microvalve as the valve 302 was 2 mm wide. The second exemplary prototype microvalve as the valve 302 was filled with air at 4500 Pa and was closed with 450 volts, much less than the 740 volts predicted by exemplary equation (6).

Coventor™ software predicts a 270 □m deflection of each surface of a 1 mm wide microvalve as the valve 302 that is made from welding two sheets of 1.4 □m thick Mylar film as the thin sheets 102. The total opening predicted would be 540 □m. The software assumed a gauge pressure of 500 Pa.

The maximum voltage the microvalve as the valve 302 can withstand in an example is determined by the breakdown strength of the Mylar as the thin sheet 102. DuPont (DuPont Teijin Films U.S. Limited Partnership, Hopewell, Va.) reports that Mylar's dielectric breakdown strength for thin films can be as high as 20 kV/mil or nearly 800 volts/□m. DuPont also reports the minimum dielectric breakdown strength for a single 1.5 μm thick film (e.g., as the thin sheet 102) is 225 volts.

The microvalves as the valve 302 in an example are made from metallized thermoplastic film with a large sheet resistance ˜1-10 Ω/square. In the event of a voltage breakdown this thin metal (˜1-10 nm) is removed in the area of the breakdown, which prevents the microvalve from being shorted out due to a defect at that location. The breakdowns in these thin films are suspected from being caused by very small pinholes. A thin Parylene layer (Specialty Coating Systems, Indianapolis, Ind.) could be deposited on the welded microvalves prior to metallization. The Parylene can seal small holes and increase the maximum voltage that can be applied to close the microvalves. Selective cuts along the z axis of the microvalve (Lᵥₐₗᵥₑ) can be made in the film to make the structure easier to bend.

The required voltage to close a valve 302 can be reduced by using parallel weld lines and/or seams as the electrically conductive material 104, to reduce the maximum opening Oₘₐₓ. This also has the result of incorporating a particle filter within the valve 302.

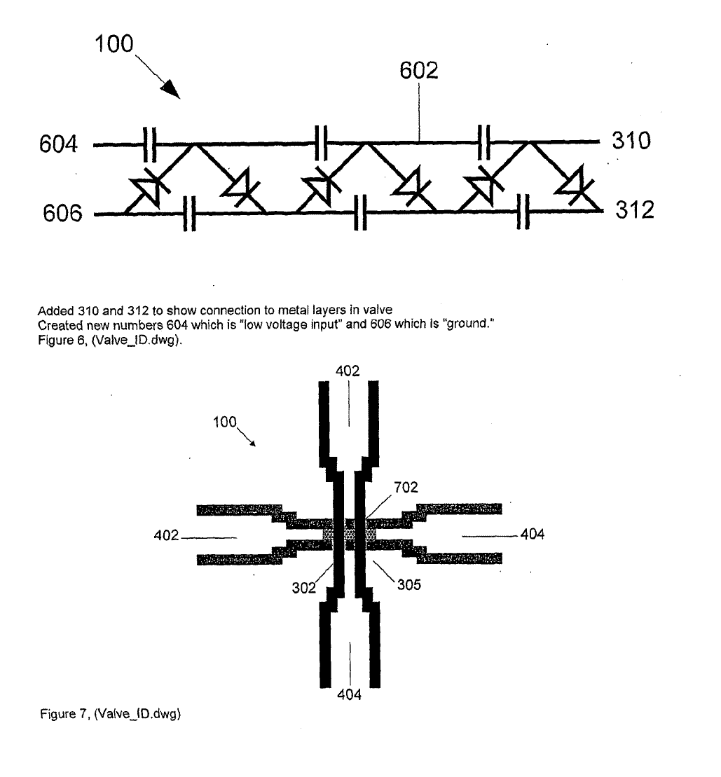

FIG. 6 is a representation of an exemplary voltage multiplier circuit 602 that is employable with the valve 302. The voltages required to close microvalves (e.g., as the valves 302) in an example are larger than typically created in many circuits. These voltages can be created in an example by adding electronics right on the microvalve with the voltage multiplier circuit 602. The voltage multiplier circuit 602 can generate on the thermoplastic film (e.g., as the thin sheet 102) the voltage necessary to close the microvalve (e.g., as the valve 302). The voltage multiplier 602 in an example can be purchased from vendors or fabricated directly on the structure. For example, interdigitated capacitors can be patterned on the thermoplastic film (e.g., as the thin sheet 102) for each multiplication stage, and an organic semiconductor can be deposited on the thermoplastic film to create the diodes. A step up transformer could also be used to generate the voltage required to close a microvalve (e.g., as the valve 302). The voltage multiplier circuit 602 in an example comprises a voltage amplifier and/or a voltage ladder.

The plurality of thin sheets 102 in an example comprises a plurality of thin, metallized, welded, compliant sheets that comprises a self-inflatable valve as the valve 302. The self-inflatable valve of the plurality of thin, metallized, welded, compliant sheets in an example is operable for valve opening and valve closure of the fluid pathway 305. The self-inflatable valve in an example is closable upon an application of an electrostatic force to the self-inflatable valve that causes the valve closure of the fluid pathway 305. The self-inflatable valve in an example opens from fluid working pressure in the fluid pathway 305 that causes the valve opening of the fluid pathway 305 absent the application of the electrostatic force to the self-inflatable valve.

The plurality of thin sheets 102 in an example comprises two thin metallized welded sheets that comprise a first weld line 304 and a second weld line 304 that comprise respective first and second thermal weld bonds of fused base material of the two thin metallized welded sheets. The first weld line 304 and the second weld line 304 define respective first and second fluid boundaries, of the plurality of fluid boundaries, of the fluid pathway 305. The two thin metallized welded sheets comprise a metallized valve that is operable for valve opening and valve closure of the fluid pathway 305. The metallized valve as the valve 302 is closable upon an application of an electrostatic force to the metallized valve that causes the valve closure of the fluid pathway 305. The metallized valve opens from fluid working pressure in the fluid pathway 305 that causes the valve opening of the fluid pathway 305 absent the application of the electrostatic force to the metallized valve.

The plurality of thin sheets 102 in an example comprises a plurality of thin, electrically-conductive-material impregnated, welded, compliant sheets that comprises a first valve 302 and a second valve 302 of the plurality of thin, electrically-conductive-material impregnated, welded, compliant sheets. The first valve 302 in an example is operable for valve opening and valve closure. The first valve 302 in an example is closable upon an application of an electrostatic force to the first valve 302 that causes the valve closure of the first valve 302. The first valve 302 in an example opens from fluid working pressure that causes the valve opening of the first valve 302 absent the application of the electrostatic force to the first valve 302. The second valve 302 in an example is operable for valve opening and valve closure. The second valve 302 in an example is closable upon an application of an electrostatic force to the second valve 302 that causes the valve closure of the second valve 302. The second valve 302 in an example opens from fluid working pressure that causes the valve opening of the second valve 302 absent the application of the electrostatic force to the second valve 302. The fluid pathway 305 in an example comprises a first fluid pathway 305 of the plurality of thin, electrically-conductive-material impregnated, welded, compliant sheets. The first valve 302 in an example is located on the first fluid pathway 305. The plurality of weld lines 304 defines a plurality of fluid boundaries of a second fluid pathway 305 of the plurality of thin, electrically-conductive-material impregnated, welded, compliant sheets. The second valve 302 in an example is located on the second fluid pathway 305. The first valve 302 in an example is operable for valve opening and valve closure of the first fluid pathway 305. The first valve 302 in an example is closable upon an application of an electrostatic force to the first valve 302 that causes the valve closure of the first fluid pathway 305. The first valve 302 in an example opens from fluid working pressure in the first fluid pathway 305 that causes the valve opening of the first fluid pathway 305 absent the application of the electrostatic force to the first valve 302. The second valve 302 in an example is operable for valve opening and valve closure of the second fluid pathway 305. The second valve 302 in an example is closable upon an application of an electrostatic force to the second valve 302 that causes the valve closure of the second fluid pathway 305. The second valve 302 in an example opens from fluid working pressure in the second fluid pathway 305 that causes the valve opening of the second fluid pathway 305 absent the application of the electrostatic force to the second valve 302.

The plurality of thin sheets 102 in an example comprises a valve 302 on the fluid pathway 305. A voltage amplifier (e.g., voltage multiplier circuit 602) of the apparatus 100 is located on the plurality of thin sheets 102 adjacent to the valve 302 and operable to apply an electrostatic force to the valve 302 that causes valve closure of the fluid pathway 305. The voltage amplifier is controllable to halt application of the electrostatic force to the valve 302 and allow fluid working pressure to cause valve opening of the fluid pathway 305.

An analysis of an exemplary microvalve as the valve 302 under the criteria outlined in the Gregory Kovacs textbook cited herein indicates these exemplary implementations of the microvalves are close to ideal in their characteristics.
a) The microvalves appear to have very low or essentially zero leakage when closed.
b) The microvalve appears to have very low or essentially zero power consumption.
c) The dead volume of the microvalve is very low.
d) The microvalves do not have “infinite differential pressure capability.”
e) Since the thermoplastic film will just deform around particulates the microvalve is expected to be relatively insensitive to reasonably low levels of particulate contamination.
f) The microvalves respond quickly to application and removal of voltage. There are three time constants that determine the microvalve actuation speed. The first time constant, τ1, is the time required to establish Poiseulle flow, which is of order (0.25*Dᵥₐₗᵥₑ²/ν_{fluid}) where □_{fluid} is the kinematic viscosity of the fluid. The proportionality constant is of order 1. The second time constant, τ2, is the time required for the microvalve structure to change shape. The ratio of mass of fluid passing through the microvalve to the microvalve mass is

$$∼ \frac{{ρ}_{fluid} {D}_{valve}}{4 {ρ}_{film} {t}_{film}} ,$$

and this ratio is much greater than one for all liquids as long as Dᵥₐₗᵥₑ>>t_{film}, and on the order of one for most gasses. The third time constant, τ3, is the time to charge or discharge the capacitor. A microvalve metallized with 10 nm of Au (2.2 Ω/square), and 1 mm wide and 6 mm long from 1.4 μm Mylar film, would have an RC time of <1 ns.
g) After the microvalve has been characterized it will have the potential to linearly vary the microvalve's cross-sectional area. A digital microvalve can be constructed with microvalves in parallel to achieve the desired flows.
h) The microvalve can be constructed from relatively inert thermoplastics like polycarbonate, polyester, polyethylene, polypropylene, polyvinylchloride, etc. These thermoplastics can operate with a wide variety of liquids and gasses.

The plurality of thin sheets 102 in an example comprises a plurality of thin welded compliant sheets that comprises the valve 302 of the fluid pathway 305. The plurality of thin welded compliant sheets in an example is capable of being deformed by a dimension on an order of a size of the valve 305. The plurality of thin welded compliant sheets in an example is deformable around a plurality of particulates to effect substantial insensitivity of the valve 302 to low levels of particulate contamination. An example of low levels of particulate contamination would be an average spacing between particulates of two times the particulate diameter, and particulates approximately less than one third the width of the valve.

The plurality of thin sheets 102 in an example comprises a substantially linearly-varying cross-sectional area valve as a valve 302 on the fluid pathway 305.

The microvalve as the valve 302 in an example can be welded with a direct write laser system, joule heating from an embedded wire, hot air system, hot bar system, and/or by laser welding through a mask. An exemplary technique is disclosed in U.S. Pat. No. 6,465,757 issued to Chen on Oct. 15, 2002 with listed assignee Leister Process Technologies and entitled “Laser Joining Method and a Device for Joining Different Workpieces Made of Plastic or Joining Plastic to Other Materials.” A number of direct write laser systems require welding clear to opaque plastic film, however very thin thermoplastic films are difficult to obtain with high opacities.

Short pulses over the DC breakdown strength of the film in an example can be applied to the microvalve to facilitate closing the structure as the valve 302. An exemplary fluidic circuit board in an example is provided. An exemplary technique can create an arbitrary interconnection of tubes connecting M inlets with N outlets provided the fluid paths do not have to cross and can be defined between two thermoplastic layers as the thin sheets 102. A fluidic circuit board with multi-level tubes where the fluidic paths can cross at different levels can be created by selectively welding pairs of successive thermoplastic films as the thin sheets 102. An exemplary implementation avoids welding of the previously welded lower layers of the thin sheets 102. This can be accomplished in an example with the following exemplary techniques.

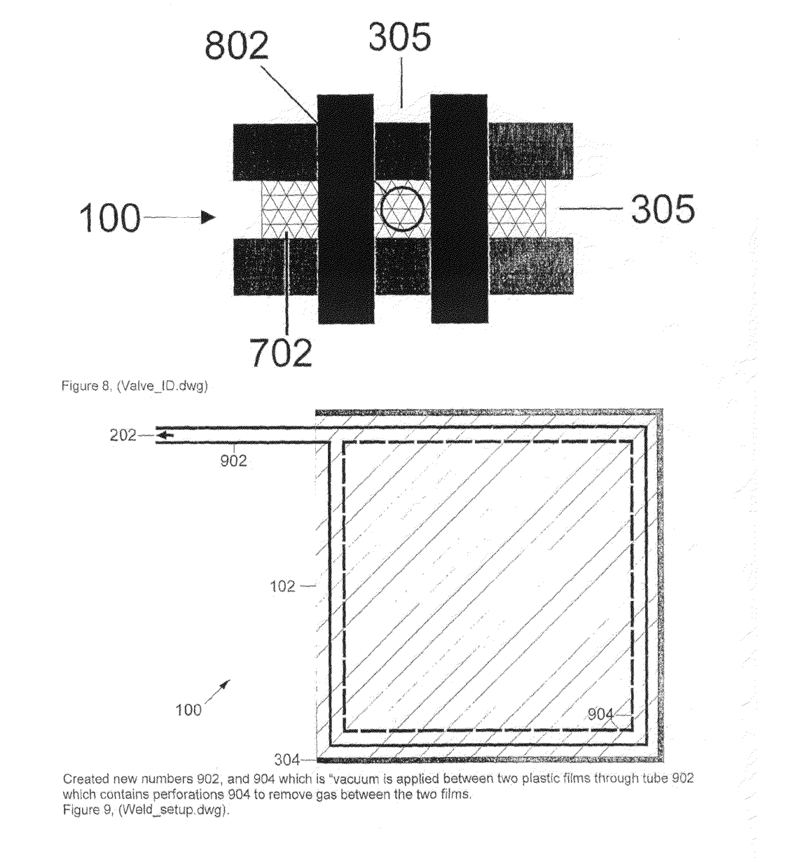

FIG. 7 is a representation of an exemplary multiplication of the valve 302 and/or the fluid pathway 305. A film 702 serves to prevent layers i & i+1 (or earlier layers when desired) from welding while layers i+1 & i+2 are welded. The layers i & i+1 in an example comprise thin sheets 102 that comprise a first valve 302 and/or fluid pathway 305. The layers i+1 & i+2 in an example comprise thin sheets 102 that comprise a second valve 302 and/or fluid pathway 305. The film 702 in an example comprises a sufficiently-thick film and/or thick enough metal film to prevent layers the i & i+1 (or earlier layers when desired) from welding while the layers i+1 & i+2 are welded.

A fluidic circuit board in an example can be built up from multiple layers of thermoplastic film as the thin sheets 102. Fluid pathways 305 can cross provided steps are taken to prevent welding earlier structures where fluid pathways 305 otherwise might be blocked. A thick metal film as the film 702 defined by lift-off, etching, and/or other techniques in an example is located in a region between two layers as two thin sheets 102 of the first valve 302 and/or fluid pathway 305. Inlet 402 and outlet 404 of the first fluid pathway 305 in an example are then defined between the two layers by welding. A third layer as a thin sheet 102 for a second fluid pathway 305 is placed on top of the second layer for the first fluid pathway 305, and the second layer also serves as the other thin sheet 102 for the second fluid pathway 305. A vacuum is applied between these second and third layers as two thin sheets 102 of the second valve 302 and/or fluid pathway 305. Inlet 402 and outlet 404 of the second fluid pathway 305 in an example are then defined between the second and third layers by laser welding. The fluidic path of the first fluid pathway 305 between the inlet 402 and outlet 404 is not blocked during and/or by this welding operation since the thick metal film (e.g., less than 1 □m) as the film 702 prevents the first and second layers from (e.g., further) welding at the time of the welding of the second and third layers. The presence of film 702 will limit the maximum opening “Omax” of both indicated fluid pathways but it is not thick enough to prevent either fluid pathway from opening with reasonable gauge pressure. A reasonable thickness for film 702 is approximately 0.1 to 3 microns.

FIG. 8 is an enlarged partial representation similar to FIG. 7 and represents an exemplary fluidic connection 802 between the fluid pathways 305. The fluid connection 802 is optional in an exemplary implementation. The fluid connection 802 in an example comprises an opening between the fluid pathways 305. In an example, a hole as the fluid connection 802 can be drilled in the second layer at the intended path intersection of the first and second fluid pathways 305, for example, prior to the welding operation between the second and third layers to create the second fluid pathway 305.

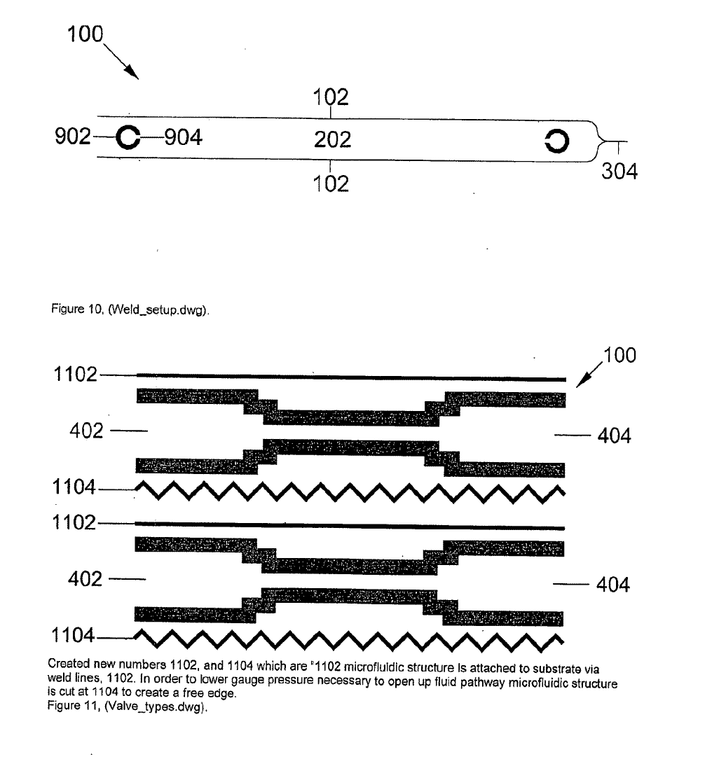

Vacuum can be applied to layers i+1 & i+2 while positive pressure is applied to the channels defined between layers i & i+1. A vacuum fixture is illustrated in FIGS. 9 and 10.

Vacuum can be applied to layers i+1 & i+2 while an electrostatic force is applied to the lower layers to pull them away from the welding regions.

Vacuum can be applied to layers i+1 & i+2 while gravity is used to pull the lower layers away from the welding regions.

One implementation makes fluid connections between successive layers of a multi-level fluidic circuit board. This can be accomplished using a CO₂, excimer laser, or other technique to selectively remove material from any thermoplastic layer in the sequence of films. The openings created can be prevented from passing through to the lower layers using the standard techniques to limit or block removal of material (time, number of pulses, chemical change at earlier layer, vision system, light transmission change, etc.) or by using the methods described above to avoid welding lower layers, particularly the thick metal film. If an opening was created in layer 2 at the intersection of the two fluid paths shown in FIG. 8 then fluid could pass from between layers 1&2, to a path confined between layers 2&3.

Referring to FIGS. 9 and 10, vacuum is applied between the two films to be welded together. This pushes the films together with a pressure of ˜15 psi without any solid object contacting the hot plastic during the welding operation.

FIGS. 9 and 10 provide an exemplary top view of weld apparatus. Vacuum is applied to interior of two sheets of film. Welding, taping, or otherwise clamping exterior edges of the films improves the vacuum that can be applied to the interior of the films.

FIG. 11 provides an exemplary cross section view of the weld apparatus.

Referring to FIG. 11, a fully compliant structure in one example has one free edge for each fluidic path. This serves in one example to promote a reduction in the stress in the film as the fluidic paths become fully circular. A fully circular path indicates a contraction from Wᵥₐₗᵥₑ to Dᵥₐₗᵥₑ or 36% (1-2/π). Coventor™ simulations indicate that when the structures are not fully compliant in one example they require greater pressures to reach the same maximum openings, and higher voltages to close.

The first layer of the microfluidic circuit board could be a rigid and non-compliant substrate. If the substrate was made of a thermoplastic material the first compliant film could be welded to it at desired locations to anchor the film. If it was not possible or desired to weld to the substrate, then the substrate in one example could be artificially roughened where a mechanical bond was desired between the film and the substrate. After the film is attached to the substrate, cuts in the film can be made in one example to increase the compliance of the defined microfluidic structures. This is illustrated in FIG. 11.

Planarization of the fluidic circuit board in one example can be achieved by inserting thicker less compliant layers into the structure. These thicker layers can be leveled with bladders made out of the compliant layers.

Reservoirs

Reservoirs of trapped fluids, or a fluid containing solid particles can be created be using techniques described above

Multi-Level Valves

Using the fluidic circuit board described previously a multilevel valve can be created where the pressure to close a valve can be generated by closing a reservoir of trapped fluid. The advantage of this method is electrical isolation of the valve, and achieving larger pressure. This concept is illustrated in FIG. 11.

The ability to seal against larger gauge pressures in a valve can be achieved by applying electrostatic pressure to an adjacent reservoir(s). The reservoir generates a high gauge pressure because of the smaller gaps between weld lines or nodes.

Compliant Force, Torque, Acceleration, and Temperature Sensors

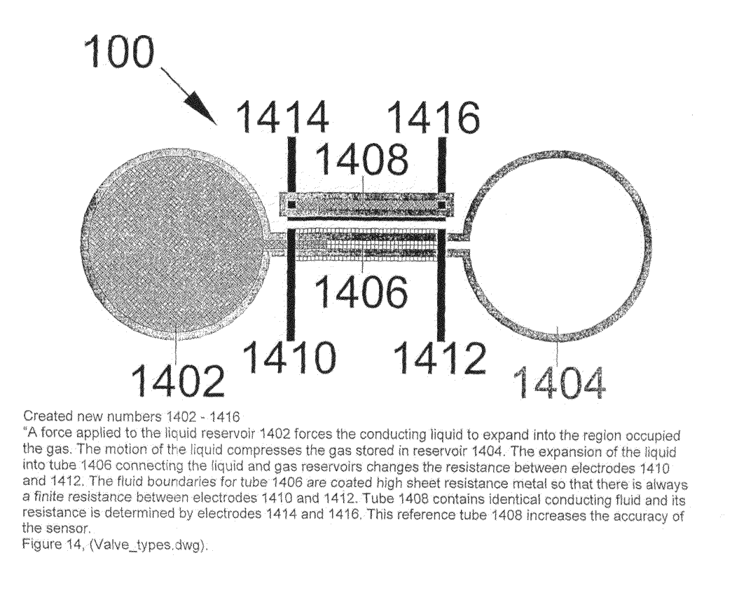

Using combinations of the techniques described above allows the generation of inexpensive sensors. As an example a force sensor can be generated by allowing the force to act on a conducting liquid filled reservoir connected by a tube to a gas filled reservoir. As the pressure on the liquid increases it partially expands into the connecting tube and compresses the gas in the gas reservoir. The connecting tube is metallized with a sheet resistance comparable to the fluid's resistivity divided by the tube's/diameter. The resistance between points 1 & 2 in FIG. 14 can be used to measure the liquid's position within the tube. Adjacent to the force sensor would be a sealed channel to measure the resistance of the liquid as a function of temperature. This method can also be used to measure torque by positioning the gas reservoir at a larger radius than the liquid reservoir. This method can also be applied to create acceleration sensors. Force, torque, and acceleration measurements typically involve measurements of changes in very small capcitances. This method allows for a simpler measurement of fluid resistance. The diameter of the connecting tube must be small enough to preserve the liquid/gas boundary.

A force applied to the liquid reservoir forces the liquid to expand into the region occupied the gas. As the liquid expands into the tube connecting the liquid and gas reservoirs the resistance between points 1& 2 changes. An adjacent tube filled with the same liquid can be used to measure the temperature of the fluid to increase the accuracy of the sensor.

Electronic Components:

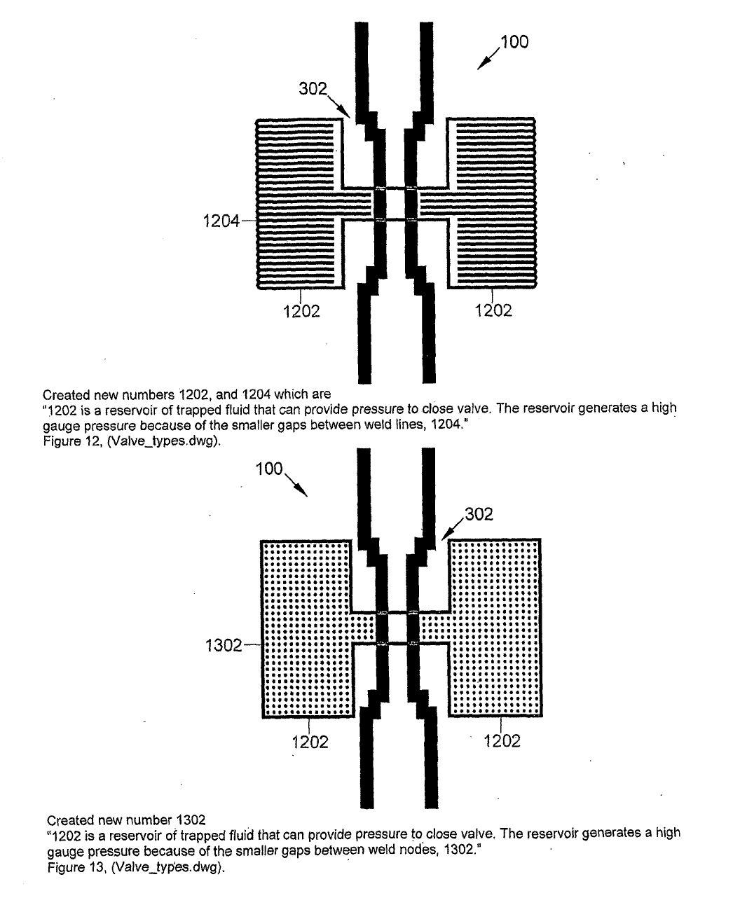

A modification of the device shown in FIG. 14 can be used to create a variable capacitor or inductor. If the connecting tube between the liquid and gas reservoirs is metallized above and below the tube than the capacitance changes by approximately the ratio of the average tube opening to the film thickness as the liquid expands into the connecting tube. Using a ˜3 mm tube opening and 1.5 mm thick film gives a capacitance ratio of ˜1000. Most variable capacitors have a limited dynamic range of ˜10. A multi-level valve would be used to force the conducting fluid to fill the connecting tube, or an array of weld lines or spots as shown in FIGS. 12 and 13. Creating a coil around the connecting tube and using a ferromagnetic fluid allows the creation of a variable inductor.

Pump: Sequence of three valves is a pump.

This disclosure also applies to other materials that can be obtained in thin sheets that can be welded together.

In one example, a first thin sheet of thermoplastic polymer film is welded with a second thin sheet of thermoplastic polymer film to form a first welded region for a valve. The first thin sheet of thermoplastic polymer film is welded with the second thin sheet of thermoplastic polymer film to form a second welded region for the valve that is separated from the first welded region. A thin metal coating is deposited on one or more of the first thin sheet of thermoplastic polymer film and/or the second thin sheet of thermoplastic polymer film. The valve is caused to close upon an application of an electrostatic force to the thin metal coating.

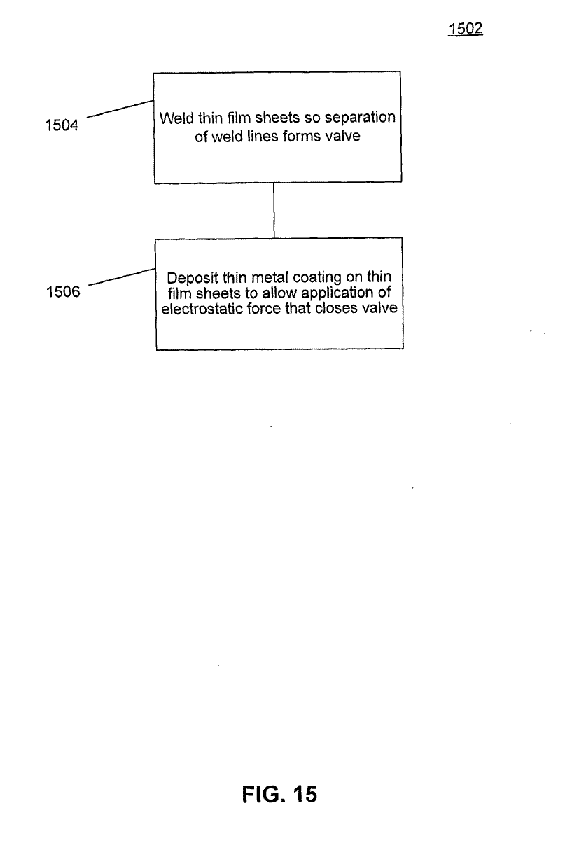

An illustrative description of an exemplary operation of an implementation of the apparatus 100 is presented, for explanatory purposes. Turning to FIG. 15, in exemplary logic flow 1502, Step 1504 welds thin film sheets as the thin sheets 102 so separation of the weld lines 304 forms the valve 302. Step 1506 deposits thin metal coating as the electrically conductive material 104, on thin film sheets as the thin sheets 102 to allow application of electrostatic force that closes the valve 302.

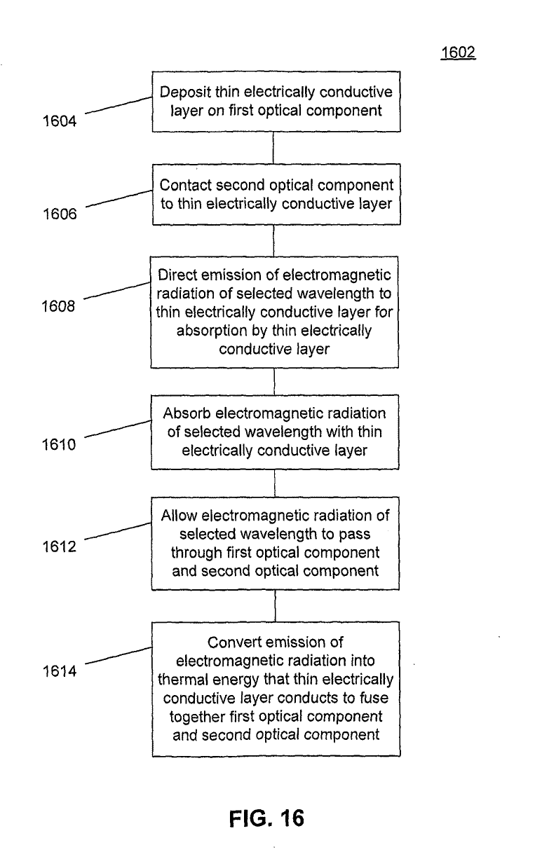

Turning to FIG. 16, in exemplary logic flow 1602, Step 1604 deposits a thin electrically conductive layer as the electrically conductive material 104, on a first optical component as a thin sheet 102. Step 1606 contacts a second optical component as a thin sheet 102, to the thin electrically conductive layer as the electrically conductive material 104. Step 1608 directs emission of electromagnetic radiation of a selected wavelength to the thin electrically conductive layer as the electrically conductive material 104, for absorption by the thin electrically conductive layer as the electrically conductive material 104. Step 1610 absorbs electromagnetic radiation of the selected wavelength with the thin electrically conductive layer as the electrically conductive material 104. Step 1612 allows electromagnetic radiation of the selected wavelength to pass through the first optical component and the second optical components as the thin sheets 102. Step 1614 converts an emission of the electromagnetic radiation into thermal energy that the thin electrically conductive layer as the electrically conductive material 104 conducts to fuse together the first optical component and the second optical components as the thin sheets 102.

An apparatus in an example comprises a plurality of thin welded sheets that comprises a plurality of weld lines that defines a plurality of fluid boundaries of a fluid pathway of the plurality of thin welded sheets.

In an example, two thin, compliant, thermoplastic polymer film sheets are welded so a separation of weld lines between the two thin, compliant, thermoplastic polymer film sheets forms a valve. A thin metal coating is deposited on at least a portion of the two thin, compliant, thermoplastic polymer film sheets to allow an application of an electrostatic force to the thin metal coating that closes the valve.

In a further example, a thin electrically conductive layer is deposited on at least a portion of a first optical component. The thin electrically conductive layer serves to absorb electromagnetic radiation of a selected wavelength. The first optical component is optically transparent and allows electromagnetic radiation of the selected wavelength to pass therethrough. The thin electrically conductive layer comprises a thickness between ten nanometers and one micron. A second optical component is contacted to the thin electrically conductive layer on the first optical component. The second optical component is optically transparent and allows electromagnetic radiation of the selected wavelength to pass therethrough. An emission of electromagnetic radiation of the selected wavelength is directed to the thin electrically conductive layer for absorption by the thin electrically conductive layer. The thin electrically conductive layer converts at least a portion of the emission of electromagnetic radiation into thermal energy that the thin electrically conductive layer conducts to the first optical component and the second optical component to fuse together the first optical component and the second optical component.

An implementation of the apparatus 100 in an example comprises a plurality of components such as one or more of electronic components, chemical components, and/or mechanical components. A number of such components can be combined or divided in an implementation of the apparatus 100. An implementation of the apparatus 100 in an example comprises any (e.g., horizontal, oblique, or vertical) orientation, with the description and figures herein illustrating exemplary orientation of an exemplary implementation of the apparatus 100, for explanatory purposes.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
a plurality of thin welded sheets that comprises a plurality of weld lines that defines a plurality of fluid boundaries of a fluid pathway of the plurality of thin welded sheets.

2. The apparatus of claim 1, wherein the plurality of weld lines comprises a plurality of thermal weld bonds of fused base material of the plurality of thin welded sheets.

3. The apparatus of claim 1, wherein the plurality of thin welded sheets comprises a plurality of thin, metallized, welded, compliant, biologically substantially inert sheets that is foldable without damage to the plurality of thin, metallized, welded, compliant, biologically substantially inert sheets, wherein the plurality of weld lines comprises a plurality of thermal weld bonds of fused base material of the plurality of thin, metallized, welded, compliant, biologically substantially inert sheets, wherein the plurality of fluid boundaries comprises a plurality of chemically substantially inactive and biologically substantially inert fluid boundaries, wherein the fluid pathway comprises a biological fluid pathway, wherein the plurality of thin, metallized, welded, compliant, biologically substantially inert sheets comprises the plurality of thermal weld bonds that defines the plurality of chemically substantially inactive and biologically substantially inert fluid boundaries of the biological fluid pathway.

4. The apparatus of claim 1, wherein the plurality of thin welded sheets comprises two thin welded compliant sheets that comprise a first thermal weld line and a second thermal weld line that comprise fused base material of the two thin welded compliant sheets;
wherein the first thermal weld line and the second thermal weld line define respective first and second fluid boundaries, of the plurality of fluid boundaries, of the fluid pathway;
wherein the two thin welded compliant sheets comprise at least one free edge that is:
free to move; and
located adjacent to the first thermal weld line and/or the second thermal weld line.

5. The apparatus of claim 1, wherein the plurality of thin welded sheets comprises a plurality of thin welded compliant sheets that comprises:
a valve of the fluid pathway; and
at least one free edge that is free to move:
toward an axis of the valve in response to an increase in fluid flow volume in the valve of the fluid pathway; and
away from the axis of the valve in response to a decrease in fluid flow volume in the valve of the fluid pathway.

6. The apparatus of claim 1, wherein the plurality of thin welded sheets comprises a plurality of thin welded compliant sheets that comprises a self-inflatable valve of the fluid pathway, wherein the self-inflatable valve is inflatable by fluid working pressure in the fluid pathway.

7. The apparatus of claim 6, wherein the plurality of thin welded sheets comprises a plurality of thin, metallized, welded, compliant sheets that comprises the self-inflatable valve, wherein the self-inflatable valve of the plurality of thin, metallized, welded, compliant sheets is operable for valve opening and valve closure of the fluid pathway, wherein the self-inflatable valve is closable upon an application of an electrostatic force to the self-inflatable valve that causes the valve closure of the fluid pathway, wherein the self-inflatable valve opens from fluid working pressure in the fluid pathway that causes the valve opening of the fluid pathway absent the application of the electrostatic force to the self-inflatable valve.

8. The apparatus of claim 1, wherein the plurality of thin welded sheets comprises a plurality of thin welded compliant sheets that comprises a valve of the fluid pathway, wherein the plurality of thin welded compliant sheets is capable of being deformed by a dimension on an order of a size of the valve.

9. The apparatus of claim 1, wherein the plurality of thin welded sheets comprises a plurality of thin welded compliant sheets that comprises a valve of the fluid pathway, wherein the plurality of thin welded compliant sheets is deformable around a plurality of particulates to effect substantial insensitivity of the valve to low levels of particulate contamination.

10. The apparatus of claim 1, wherein the plurality of thin welded sheets comprises a valve of the fluid pathway, wherein a thickness of the plurality of thin welded sheets is substantially less than a width of the valve.

11. The apparatus of claim 1, wherein the plurality of thin welded sheets comprises two thin metallized welded sheets that comprise a first weld line and a second weld line that comprise respective first and second thermal weld bonds of fused base material of the two thin metallized welded sheets;
wherein the first weld line and the second weld line define respective first and second fluid boundaries, of the plurality of fluid boundaries, of the fluid pathway;
wherein the two thin metallized welded sheets comprise a metallized valve that is operable for valve opening and valve closure of the fluid pathway, wherein the metallized valve is closable upon an application of an electrostatic force to the metallized valve that causes the valve closure of the fluid pathway, wherein the metallized valve opens from fluid working pressure in the fluid pathway that causes the valve opening of the fluid pathway absent the application of the electrostatic force to the metallized valve.

12. The apparatus of claim 1, wherein the plurality of thin welded sheets comprises a plurality of thin, electrically-conductive-material impregnated, welded, compliant sheets that comprises a first valve and a second valve of the plurality of thin, electrically-conductive-material impregnated, welded, compliant sheets;
wherein the first valve is operable for valve opening and valve closure, wherein the first valve is closable upon an application of an electrostatic force to the first valve that causes the valve closure of the first valve, wherein the first valve opens from fluid working pressure that causes the valve opening of the first valve absent the application of the electrostatic force to the first valve;
wherein the second valve is operable for valve opening and valve closure, wherein the second valve is closable upon an application of an electrostatic force to the second valve that causes the valve closure of the second valve, wherein the second valve opens from fluid working pressure that causes the valve opening of the second valve absent the application of the electrostatic force to the second valve.

13. The apparatus of claim 12, wherein the fluid pathway comprises a first fluid pathway of the plurality of thin, electrically-conductive-material impregnated, welded, compliant sheets, wherein the first valve is located on the first fluid pathway, wherein the plurality of weld lines defines a plurality of fluid boundaries of a second fluid pathway of the plurality of thin, electrically-conductive-material impregnated, welded, compliant sheets, wherein the second valve is located on the second fluid pathway;
wherein the first valve is operable for valve opening and valve closure of the first fluid pathway, wherein the first valve is closable upon an application of an electrostatic force to the first valve that causes the valve closure of the first fluid pathway, wherein the first valve opens from fluid working pressure in the first fluid pathway that causes the valve opening of the first fluid pathway absent the application of the electrostatic force to the first valve;
wherein the second valve is operable for valve opening and valve closure of the second fluid pathway, wherein the second valve is closable upon an application of an electrostatic force to the second valve that causes the valve closure of the second fluid pathway, wherein the second valve opens from fluid working pressure in the second fluid pathway that causes the valve opening of the second fluid pathway absent the application of the electrostatic force to the second valve.

14. The apparatus of claim 1, wherein the plurality of thin welded sheets comprises a valve on the fluid pathway, the apparatus further comprising:
a voltage amplifier located on the plurality of thin welded sheets adjacent to the valve and operable to apply an electrostatic force to the valve that causes valve closure of the fluid pathway, wherein the voltage amplifier is controllable to halt application of the electrostatic force to the valve and allow fluid working pressure to cause valve opening of the fluid pathway.

15. The apparatus of claim 1, wherein the plurality of thin welded sheets comprises a substantially linearly-varying cross-sectional area valve on the fluid pathway.

16. A process, comprising the steps of:
welding two thin, compliant, thermoplastic polymer film sheets so a separation of weld lines between the two thin, compliant, thermoplastic polymer film sheets forms a valve; and
depositing a thin metal coating on at least a portion of the two thin, compliant, thermoplastic polymer film sheets to allow an application of an electrostatic force to the thin metal coating that closes the valve.

17. A process, comprising the steps of:
depositing a thin electrically conductive layer on at least a portion of a first optical component, wherein the thin electrically conductive layer serves to absorb electromagnetic radiation of a selected wavelength, wherein the first optical component is optically transparent and allows electromagnetic radiation of the selected wavelength to pass therethrough, wherein the thin electrically conductive layer comprises a thickness between ten nanometers and one micron;
contacting a second optical component to the thin electrically conductive layer on the first optical component, wherein the second optical component is optically transparent and allows electromagnetic radiation of the selected wavelength to pass therethrough; and
directing an emission of electromagnetic radiation of the selected wavelength to the thin electrically conductive layer for absorption by the thin electrically conductive layer;
wherein the thin electrically conductive layer converts at least a portion of the emission of electromagnetic radiation into thermal energy that the thin electrically conductive layer conducts to the first optical component and the second optical component to fuse together the first optical component and the second optical component.
